(19) United States
(12) Patent Application Publication
(10) Pub. No.: US 2007/0013703 A1
(43) Pub. Date: Jan. 18, 2007

(54) Device for state sharing high-reliability in a computer system

(75) Inventors: Ivano Tortolini, Pomezia (IT); Filippo Dini, Firenze (IT)

Correspondence Address: MODIANO & ASSOCIATI, Via Meravigli, 16, MILAN, 20123, IT

(73) Assignee: BABEL S.R.L.

(21) Appl. No.: 11/455,836

(22) Filed: Jun. 20, 2006

(30) Foreign Application Priority Data
Jul. 15, 2005 (IT) MI2005A001358

(51) Int. Cl. G06T 1/60

(52) U.S. Cl. 345/530

(57) ABSTRACT

A device for sharing states and information in a high-reliability or high-availability computer system, comprising a switch provided with a memory constituted by a memory key, said switch being connectable to at least one pair of computers by means of respective cables, the computers of said pair of computers being connected to each other for synchronization.

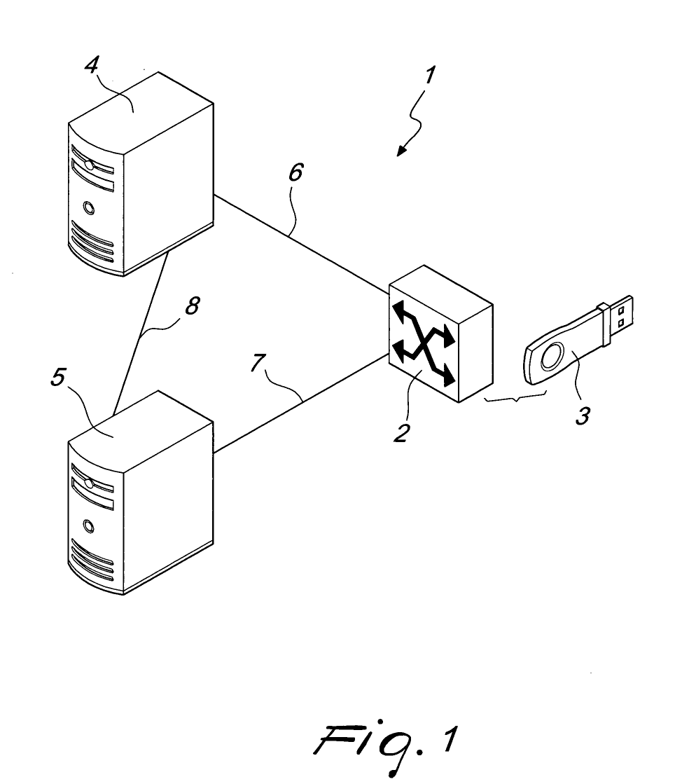

The present invention relates to a device for state sharing in a high-reliability computer system. More particularly, the invention relates to a device for state sharing of at least one pair of mutually synchronized computers.

### BACKGROUND OF THE INVENTION

As is known, when it is necessary to share the states of a high-reliability or high-availability software program, i.e., software which must be able to continue operating (for example a mail server, a monitoring system, etc) even if a fault occurs in the computer on which the software is installed, it is customary to make the software program redundant by installing it on a second computer, which necessarily has to be synchronized with the first one.

In this way, if the first computer crashes, the second computer can take control of the software program and continue ensuring its operation.

Of course, in order to do this, the two computers and the data related to the software program must remain synchronized with each other as much as possible. For this purpose, either a direct connection (for example a parallel, serial cable) or a network connection is normally used.

Therefore, when a computer crashes, the second computer can continue from the situation that existed when the first computer ceased operating.

Of course, this solution is extremely effective until a situation occurs in which the second computer also crashes, for example but not necessarily simultaneously with the first computer or, in any case, when the first computer has not yet been restored.

In this case, the availability of the software would not be ensured, since the software program could no longer be operating.

Currently there are different proposed solutions for overcoming the drawback described above.

A first solution consists in connecting a third computer in a network to the first two, such third computer storing the state of the first two. If a failure of both of the first two computers occurs, the third computer, by having in its memory the state of each of the two computers, is capable of resuming the operation of one of the two computers, i.e., the one that at the time had control of the software program and the up-to-date data, and thus can ensure that the program can be operational again without any interruption or data loss.

A second solution consists in using a shared hard disk, for example of the SCSI type, which in addition to being usable to share data among the two computers can also store their state, so as to constitute a memory from which it is possible to draw in order to ensure the operation of the software program or a restore from a failure situation.

However, the solutions proposed above suffer the drawback of being very expensive, since the first solution requires a third computer, with all the associated costs, and the second solution requires a third hard disk with extremely complex and expensive control electronics.

Moreover, both solutions entail the use of systems with moving parts, for example hard disks, which are also easily subject to failures.

### SUMMARY OF THE INVENTION

The aim of the present invention is to provide a device for sharing states and information in a high-reliability or -availability computer system, which allows to ensure the uninterrupted operation of a software program installed on a computer.

Within this aim, an object of the present invention is to provide a device for sharing states and information in a high-reliability or high-availability computer system which is highly reliable from the point of view of operation since it is substantially devoid of moving parts subject to failures.

Another object of the present invention is to provide a device for sharing states and information in a high-reliability or high-availability computer system which allows to reduce costs with respect to known types of solutions.

Another object of the present invention is to provide a device for sharing states and information in a computer system which is highly reliable or available and is relatively simple to provide and at competitive costs.

This aim and these and other objects, which will become better apparent hereinafter, are achieved by a device for sharing states and information in a high-reliability or high-availability computer system, comprising a switch provided with memory means constituted by a memory key, said switch being connectable to at least one pair of computers by means of respective cables, the computers of said pair of computers being connected to each other for synchronization.

### BRIEF DESCRIPTION OF THE DRAWING

Further characteristics and advantages of the invention will become better apparent from the description of a preferred but not exclusive embodiment of the device according to the invention, illustrated by way of non-limiting example in the accompanying drawing, wherein the only FIGURE is a schematic view of the use of the device according to the invention associated with the pair of computers.

### DESCRIPTION OF THE PREFERRED EMBODIMENTS

With reference to the FIGURE, the device according to the present invention, generally designated by the reference numeral 1, comprises a switch 2, for example of the USB type, with which a memory key 3, for example also of the USB type, is associated, such memory key being adapted to allow to store the state of at least one pair of machines or computers, designated by the reference numerals 4 and 5 in the FIGURE.

For mutual synchronization, the two computers 4 and 5 must be connected to each other either directly, for example by means of a parallel or serial cable 8, or over a network.

The switch 2 is connected to each computer 4 and 5 by means of an appropriate cable, designated respectively by the reference numerals 6 and 7, for example of the USB type.

Therefore, a software application or program running on one of the two computers 4 and 5 can be kept in operation even if the second computer, for example 5, is unable to provide redundancy for the first computer 4, for example due to a sudden failure.

If both computers 4 and 5 have failed, the switch 2 is capable of sharing the states of the two computers 4 and 5 by means of the USB memory key 3, which is shared by the nodes (computers 4 and 5) of the system by means of the switch 2.

The memory key 3 therefore acts as an external memory for maintaining the operating state of the two computers 4 and 5, with a relatively low cost.

It is of course possible to control, by means of the switch 2, at least one pair of computers 4 and 5 and optionally a plurality of pairs of computers 4 and 5 by using the same memory key 3, which in this case must be sized appropriately as regards its memory capacity.

It is also possible to connect to the switch 2, in addition to the memory key 3, a disk of the USB type, not shown, in order to increase the capacity of the memory available.

Substantially, the memory key constitutes a memory unit which is shared by the computers 4 and 5, with an extremely low cost and an extremely high reliability thanks to the absence of moving parts.

The operation of a system comprising a device for sharing the states in a high-reliability computer system is similar to the operation of a conventional clustering system, wherein the state of the connected machines is stored, however, in the USB memory key 3 connected to the switch 2.

In particular, one or more computer applications requiring high reliability and high availability, i.e., the need to keep the service to which they are assigned always available regardless of failure situations, are installed on the two machines 4 and 5, wherein the instance of the application that runs on one machine, for example the computer 4, acts as primary instance and the instance that runs on the second machine, for example the computer 5, acts as a backup instance.

In conditions of correct operation of both computers 4 and 5, the computer 4 writes on the USB memory key 3 information which is sufficient to identify the state of machine 4 and of the application being considered. Similar operations are performed by the machine 5. Moreover, because of the technical nature of the shared resource, i.e., the USB memory key 3, access management on the part of the machines 4 and 5 is inherent in the device, since it is the software program of the two machines itself that blocks the resource, i.e., prevents writing on the part of the other machine, during writing steps by means of the interaction with the switch 2. This prevents the two machines 4 and 5 from trying to write simultaneously on the memory key 3, thus avoiding situations of potential inconsistency.

At the same time, the two machines, by means of conventional mechanisms and techniques which are well known to the person skilled in the art, exchange data with each other via the direct connection 8, in order to maintain as much as possible a synchronized state among the data of the application being considered.

If the machine 4 on which the currently active instance of the application is running crashes, or if the instance of said application freezes, the machine 5 detects the need to take control of the application and takes over from the machine 4 in providing the corresponding service.

The USB memory key 3 contains, at this point, information related to the new situation.

If the machine 4 is restored, it is then possible, after a conventional resynchronization of the data between the machines 4 and 5, to make the corresponding instance of the application operational again, so as to recover the original distribution of the software programs and optimize the load on the two computers 4 and 5.

If instead the machine 5 also crashes before the machine 4 is restored, the last valid state remains in any case stored in the USB memory key 3, which inherently provides a memory of the persistent type. By doing so, when the machines 4 and 5 are restored it is possible to restart the system from the last valid state.

The solution described above allows to provide redundancy for at least one pair of computers without having to resort to a third computer or to an external hard disk, to the benefits of simplicity of installation, consequent costs and high reliability, mainly due to the absence of moving parts.

In practice it has been observed that the device according to the invention fully achieves the intended aim and objects, since it allows to constitute a memory which can be shared by at least one pair of computers with the aid of a switch which is connected by means of respective cables to each one of the two computers, which in turn are connected to each other.

The system according to the invention, when comprising at least two servers, a switch or commuter and a USB memory key, can be used as a safety device according to the same functionality provided by the known “SCSI reserve” systems, using USB devices instead of SCSI devices.

Such system can be used to overcome any error, technically known as “split brain”, due to loss of synchronization between the computers (or nodes), which could corrupt data or generate malfunctions.

The device thus conceived is susceptible of numerous modifications and variations, all of which are within the scope of the appended claims; all the details may further be replaced with other technically equivalent elements.

The disclosures in Italian Patent Application No. MI2005A001358 from which this application claims priority are incorporated herein by reference.

What is claimed is:

1. A device for sharing states in a high-reliability computer system, comprising a switch provided with memory means constituted by a memory key, said switch being connectable to at least one pair of computers by means of respective cables, the computers of said pair of computers being connected to each other for synchronization.

2. The device according to claim 1, wherein said switch is a switch of the USB type.

3. The device according to claim 1, wherein said memory key is a USB memory key.

4. The device according to claim 1, wherein said switch is connected to said computers by means of cables of the USB type.

5. The device according to claim 1, wherein said at least one pair of computers are connected to each other by means of a direct connection.

6. The device according to claim 1, wherein said at least one pair of computers are connected to each other by means of a network connection.

7. The device according to claim 1, wherein said memory key is shared by said at least one pair of computers.

8. A high-reliability computer system, comprising at least one pair of computers, which are connected to each other, and a switch, which is provided with a key-type memory which can be shared by said computers of the pair of computers.
